(19) United States
(12) Patent Application Publication
(10) Pub. No.: US 2020/0186720 A1
(43) Pub. Date: Jun. 11, 2020

(54) SYSTEM AND METHOD FOR OBJECT TRACKING WITH IMAGE-STABILIZING FUNCTION

(71) Applicant: HEIMAVISTA INC., Taipei City (TW)

(72) Inventor: Ching-Kang LEE, Taipei City (TW)

(73) Assignee: HEIMAVISTA INC., Taipei City (TW)

(21) Appl. No.: 16/212,389

(22) Filed: Dec. 6, 2018

(51) Int. Cl. H04N 5/232; G03B 17/56; G06T 7/246; H04M 1/725

(52) U.S. Cl. CPC H04N 5/23299; G03B 17/561; H04N 5/232933; H04M 2250/52; H04N 5/23248; G06T 7/246; H04M 1/72527; H04N 5/23218

(57) ABSTRACT

A method for object tracking with an image-stabilizing function is adapted for making an image capturing direction of a tracking dock approach an optical signal source. The optical signal source is configured to emit an optical positioning signal. The method includes: receiving the optical positioning signal by using an optical-signal receiving array, and generating receiving strengths separately by using a plurality of optical-signal receiving units in the optical-signal receiving array; comparing the receiving strengths, and analyzing a position of the optical signal source of the optical positioning signal relative to the optical-signal receiving array according to the receiving strengths, to generate a first turning signal; and sending the first turning signal to control the tracking dock, to enable the image capturing direction to approach the position of the optical signal source.

### BACKGROUND

### Technical Field

The present invention relates to object tracking, and in particular, to an object tracking system with an image-stabilizing function and a method for image object tracking with an image-stabilizing function.

### Related Art

Currently, various video object tracking technologies have been developed, in which a dock drives a smartphone to track a specific object. However, when the tracked object moves rapidly beyond a captured image, the smartphone cannot continue tracking due to the lack of a trackable object. Although some object tracking mechanisms have an object search mode, the object search mode is usually a blind search only, and as a result, a probability that a search fails is still high. In addition, if a tracking mechanism increases a tracking speed to prevent a tracked object from moving beyond a captured image, usually, excessive tracking occurs. The excessive tracking causes the smartphone to continuously swivel during photographing to track a specific object. As a result, a captured image (especially a dynamic video stream) is obviously shaky. Therefore, a tracking manner still needs to be improved.

### SUMMARY

In view of the above problems, the present invention proposes an object tracking system with an image-stabilizing function, including a remote control device and a tracking dock. The remote control device has: an encoding circuit; an optical signal source, electrically connected to the encoding circuit, and configured to emit an optical positioning signal; and a key group, electrically connected to the encoding circuit, and configured to be pressed to trigger the encoding circuit to drive the optical signal source to emit the optical positioning signal. The tracking dock includes: a control chip; a turning module, electrically connected to the control chip, wherein an image capturing direction is defined on the turning module, and the control chip is configured to control the turning module to turn, to change the image capturing direction; and an optical-signal receiving array, having a plurality of optical-signal receiving units, wherein the optical-signal receiving units are configured to receive the optical positioning signal, generate different receiving strengths, and transfer the receiving strengths to the control chip.

The control chip compares the receiving strengths, analyzes, according to a receiving strength distribution, an angle by which the image capturing direction needs to be changed, to generate a first turning signal, and sends the first turning signal to control the turning module to enable the image capturing direction to approach a position of the optical signal source.

In at least one embodiment, the object tracking system with an image-stabilizing function further includes: a handheld mobile device, supported on the turning module. The handheld mobile device includes: a microprocessor; a camera, electrically connected to the microprocessor, and configured to capture a captured image in the image capturing direction and transfer the captured image to the microprocessor, wherein the microprocessor defines a plurality of sampling frames having different sizes in the captured image, and loads one of the sampling frames in advance, and the microprocessor changes the loaded sampling frame according to a selection command; a memory unit, electrically connected to the microprocessor, and configured to store the captured image and set values of the sampling frames; and a touch-control display panel, electrically connected to the microprocessor, and configured to display the captured image, receive a touch control operation, and feedback the touch control operation as the selection command to the microprocessor. The microprocessor recognizes a feature object in the captured image. When the feature object moves beyond the loaded sampling frame, the microprocessor sends a second turning signal to drive the turning module to change the image capturing direction, to enable the feature object to return into the sampling frame.

In at least one embodiment, when a plurality of feature objects is recognized, the microprocessor keeps all of the feature objects in the sampling frame.

In at least one embodiment, when a plurality of feature objects is recognized, the microprocessor keeps a chosen feature object in the sampling frame according to a choosing command.

In at least one embodiment, an array type of the optical-signal receiving array is selected from a rectangular array, an annular array, a trapezoidal array, a cross-shaped array, and a combination thereof.

The present invention further proposes a method for object tracking with an image-stabilizing function, adapted for making an image capturing direction of a tracking dock approach an optical signal source. The optical signal source is configured to emit an optical positioning signal. The method includes the following steps: receiving the optical positioning signal by using an optical-signal receiving array, generating receiving strengths separately by using a plurality of optical-signal receiving units in the optical-signal receiving array; comparing the receiving strengths, and analyzing a position of the optical signal source of the optical positioning signal relative to the optical-signal receiving array according to the receiving strengths, to generate a first turning signal; and sending the first turning signal to control the tracking dock, to enable the image capturing direction to approach the position of the optical signal source.

In at least one embodiment, the method for object tracking with an image-stabilizing function further includes: establishing a communications link with a handheld mobile device, wherein the handheld mobile device captures a captured image in the image capturing direction by using a camera, generates a second turning signal, and sends the second turning signal to the tracking dock, and the tracking dock is configured to support the handheld mobile device, and receive the first turning signal or the second turning signal to change the image capturing direction; defining, by the handheld mobile device, a plurality of sampling frames having different sizes in the captured image, and loading one of the sampling frames in advance; and recognizing, by the handheld mobile device, a feature object in the captured image, and when the feature object moves beyond the loaded sampling frame, sending, by the handheld mobile device, the second turning signal to drive the tracking dock to change the image capturing direction, to enable the feature object to return into the sampling frame.

In at least one embodiment, the method for object tracking with an image-stabilizing function further includes: inputting a selection command, to enable the handheld mobile device to change the loaded sampling frame according to the selection command.

In at least one embodiment, when a plurality of feature objects is recognized, all of the feature objects are kept in the sampling frame.

In at least one embodiment, when a plurality of feature objects is recognized, a microprocessor keeps a chosen feature object in the sampling frame according to a choosing command.

In the present invention, an optical-code receiving array receives an optical positioning signal, so that a receiving angle can be effectively increased to avoid an object search failure and ensure that a feature object that needs to be tracked is kept in a captured image. In addition, in at least one embodiment, a sampling frame may be set rapidly, so that excessive tracking can be avoided, and the problem that the captured image is unstable and shaky is resolved.

### BRIEF DESCRIPTION OF THE DRAWINGS

FIG. 1 is a schematic system diagram of an object tracking system with an image-stabilizing function according to an embodiment of the present invention;

FIG. 2 is a circuit block diagram of a remote control device and a tracking dock according to an embodiment of the present invention;

FIG. 3 is a schematic diagram of a threshold group of a plurality of optical-signal receiving units in an optical-signal receiving array according to an embodiment of the present invention;

FIG. 4 to FIG. 9 show optical-signal receiving arrays in different array types according to an embodiment of the present invention;

FIG. 10 is a circuit block diagram of a handheld mobile device and a tracking dock according to an embodiment of the present invention;

FIG. 11 is a schematic diagram of a plurality of sampling frames and a selection list in a sampling image according to an embodiment of the present invention;

FIG. 12 and FIG. 13 are a schematic diagram of tracking an optical signal source according to an embodiment of the present invention;

FIG. 14 and FIG. 15 are schematic diagrams of keeping a feature object in a sampling frame according to an embodiment of the present invention;

FIG. 16 is a schematic diagram of tracking a plurality of feature objects according to an embodiment of the present invention;

FIG. 17 is a flowchart of a method for object tracking with an image-stabilizing function according to the present invention; and

FIG. 18 is another flowchart of a method for object tracking with an image-stabilizing function according to the present invention.

### DETAILED DESCRIPTION

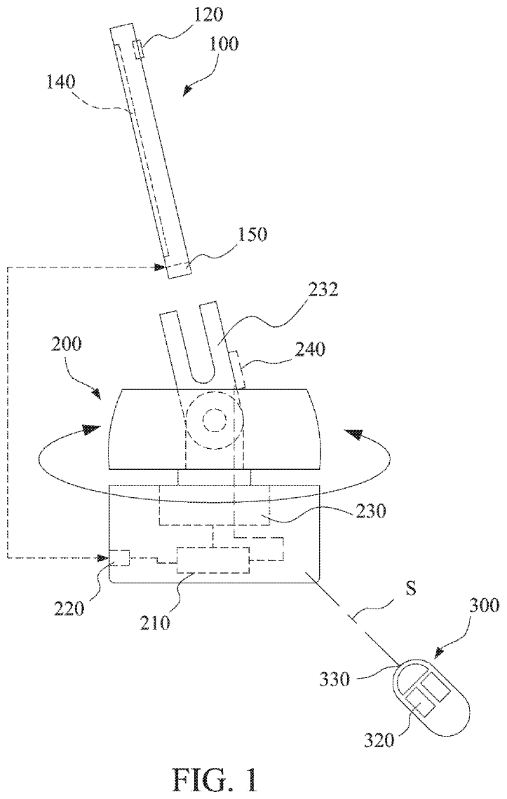

Referring to FIG. 1, an object tracking system with an image-stabilizing function disclosed in an embodiment of the present invention is configured to perform a method for object tracking with an image-stabilizing function. The object tracking system with an image-stabilizing function includes a tracking dock 200 and a remote control device 300. The tracking dock 200 has a changeable image capturing direction. A handheld mobile device 100 is supported on the tracking dock 200, and is configured to capture a captured image M in the image capturing direction. The handheld mobile device 100 may control the tracking dock 200 to rotate to change the image capturing direction of the handheld mobile device 100, to continuously track a feature object A.

As shown in FIG. 1, the tracking dock 200 may automatically change the image capturing direction, to enable the image capturing direction to approach the remote control device 300. That is, the tracking dock 200 may automatically search for the remote control device 300, to make the image capturing direction of the handheld mobile device 100 approaches the remote control device 300; and the handheld mobile device 100 is not involved in tracking the remote control 300. The handheld mobile device 100 may recognize the feature object A, to further control the tracking dock 200 to keep the feature object A in a specified range in the captured image M.

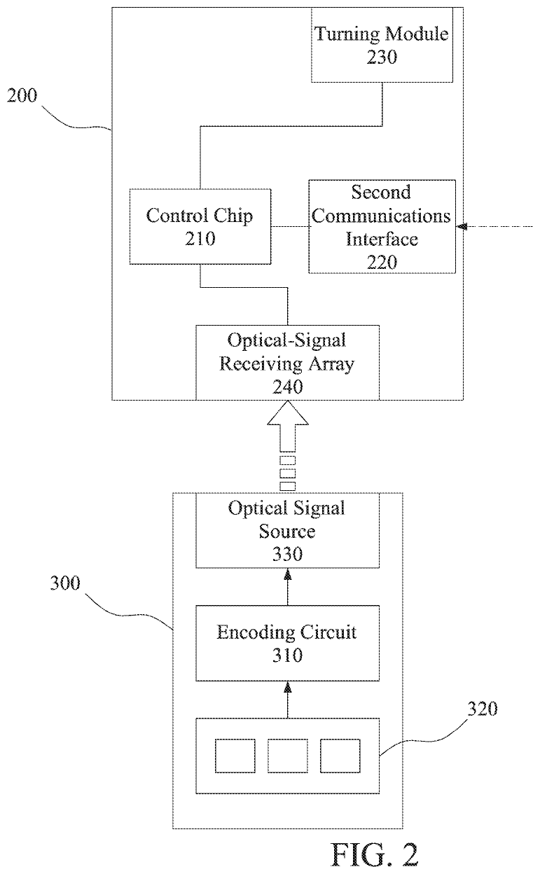

As shown in FIG. 1 and FIG. 2, the remote control device 300 has an encoding circuit 310, an optical signal source 330, and a key group 320.

The optical signal source 330 is electrically connected to the encoding circuit 310, and is configured to send an optical positioning signal S. An example is that the optical signal source 330 may be a single optical-code transmission unit or an optical-code transmission array. The key group 320 is electrically connected to the encoding circuit 310, and is configured to be pressed to trigger the encoding circuit 310 to drive the optical signal source 330 to send the optical positioning signal S for the tracking dock 200 to perform tracking.

As shown in FIG. 1 and FIG. 2, the tracking dock 200 includes a control chip 210, a second communications interface 220, a turning module 230, and an optical-signal receiving array 240.

As shown in FIG. 1 and FIG. 2, the second communications interface 220 is electrically connected to the control chip 210, and establishes a communications link with a first communications interface 150 of the handheld mobile device 100, so that the control chip 210 of the tracking dock 200 establishes a communications link with the handheld mobile device 100 to receive a second turning signal sent from the handheld mobile device 100 and transfer the second turning signal to the control chip 210.

As shown in FIG. 1 and FIG. 2, the turning module 230 is electrically connected to the control chip 210, and the turning module 230 defines the image capturing direction. Moreover, the turning module 230 is configured to support the handheld mobile device 100, so that the handheld mobile device 100 may capture the captured image M in the image capturing direction. The control chip 210 drives the turning module 230 according to the second turning signal or a first turning signal to turn to change the image capturing direction, so as to change a range covered by the captured image M.

The turning module 230 usually includes one or more motors, a necessary gear box, and a fixture 232. The fixture 232 is configured to hold the handheld mobile device 100, so as to support the handheld mobile device 100 on the turning module 230.

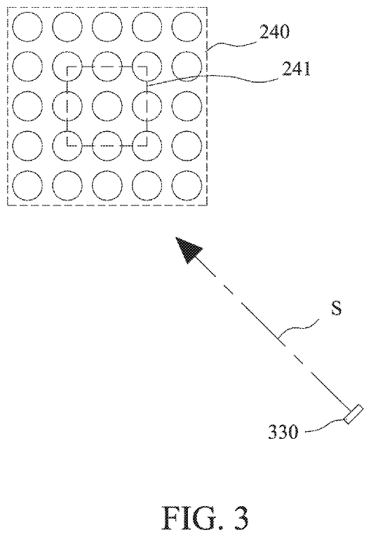

As shown in FIG. 1, FIG. 2, and FIG. 3, the optical-signal receiving array 240 is electrically connected to the control chip 210, and rotates synchronously with the turning module 230, especially, the fixture 232. The optical-signal receiving array 240 has a plurality of optical-signal receiving units, configured to receive the optical positioning signal S, and generate different receiving strengths according to respective different receiving distances and angles, to generate a receiving strength distribution and transfer the receiving strength distribution to the control chip 210.

Generally, a receiving strength is stronger as an angle of incidence of the optical positioning signal S to an optical-signal receiving unit approaches 90 degrees. The control chip 210 compares the receiving strength distribution, analyzes, according to the receiving strength distribution, an angle by which the image capturing direction needs to be changed, to generate a first turning signal, and sends the first turning signal to control the turning module 230, to enable the image capturing direction to approach a position of the optical signal source 330. Therefore, the captured image M of the handheld mobile device 100 has a chance of covering an object that carries the remote control device 300. The first turning signal is generated by the control chip 210 of the tracking dock 200, and the handheld mobile device 100 is not involved in generating the first turning signal.

As shown in FIG. 3, a manner of analyzing, according to the receiving strength distribution, an angle by which the image capturing direction needs to be changed is as follows.

A threshold group 241 may be defined in a central area of the optical-signal receiving array 240. It is set that receiving strengths of optical-signal receiving units in the threshold group 241 are required to exceed a threshold to obtain a required receiving strength distribution. That is, the image capturing direction defined by the turning module 230 at this time approaches the optical signal source 330 of the remote control device 300. If a receiving strength of at least one optical-signal receiving unit in the threshold group 241 does not reach the threshold, the optical-signal receiving array 240 is turned (that is, the turning module 230 is turned) to a direction having a relatively high receiving strength according to a position of the optical-signal receiving unit in the optical-signal receiving array 240 and receiving strengths of the other optical-signal receiving units, until the receiving strengths of all of the optical-signal receiving units in the threshold group 241 reach the threshold. A size of a range of the threshold group 241 is related to sensitivity. A smaller range of the threshold group 241 indicates a higher sensitivity, that is, the image capturing direction is closer to the optical signal source 330. To set the sensitivity, the remote control device 300 sends the value of the sensitivity in an optical encoding signal, and the optical-signal receiving array 240 of the tracking dock 200 receives the optical encoding signal and sends the optical encoding signal to the control chip 210.

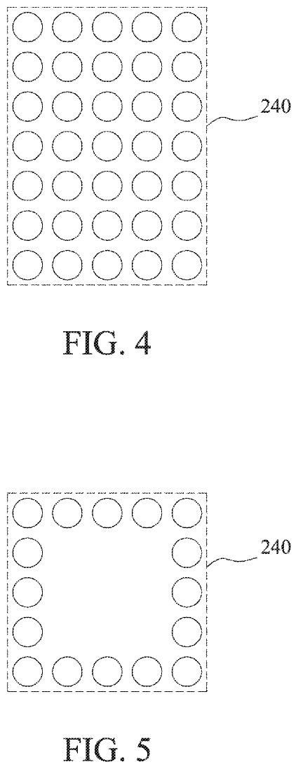

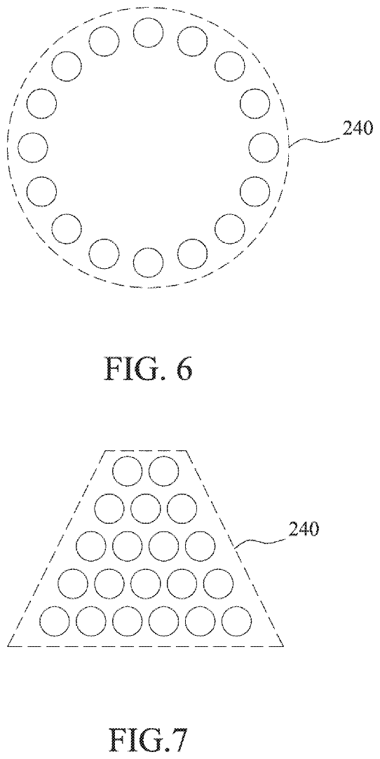

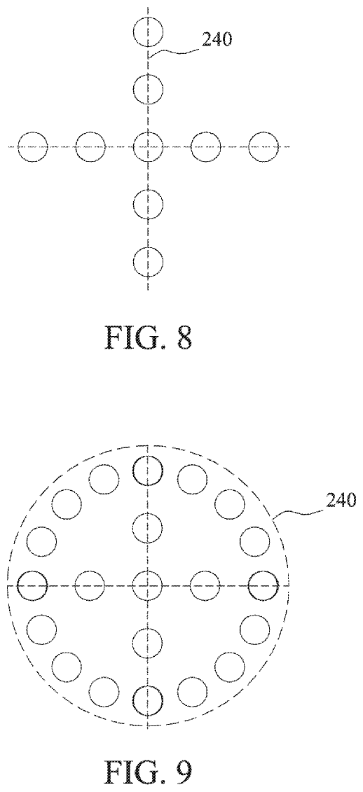

As shown in FIG. 4 to FIG. 9, a square array arranged in a plane in FIG. 3 is only an example. An array type of the optical-signal receiving array 240 may be a rectangular array, an annular array (including a circular array and a polygonal frame), a trapezoidal array (include a triangular array), a cross-shaped array, and a combination thereof, and the optical-signal receiving array 240 may be arranged on a curved surface to increase a receiving angle. The fixture 232 for fixing the optical-signal receiving array 240 on the turning module 230 in FIG. 3 is also an example, and other examples may be used provided that a receiving surface of the optical-signal receiving array 240 can rotate synchronously along with the image capturing direction defined by the turning module 230.

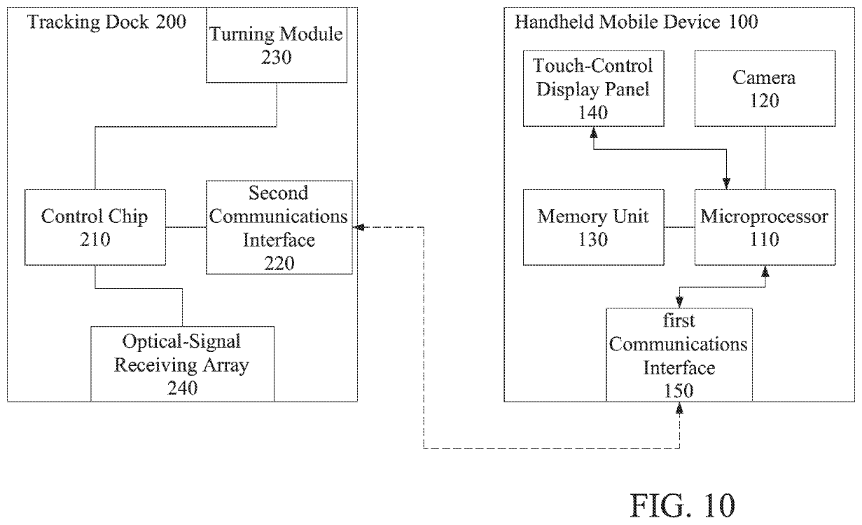

Referring to FIG. 1 and FIG. 10, the handheld mobile device 100 of the present invention may be an electronic apparatus such as a smartphone or a tablet computer that has a capturing function and a video recording function and may establish a communications link with the tracking dock 200.

As shown in FIG. 1 and FIG. 10, the handheld mobile device 100 is supported on the turning module 230, and includes a microprocessor 110, a camera 120, a memory unit 130, a touch-control display panel 140, and the first communications interface 150.

As shown in FIG. 1 and FIG. 10, the camera 120, the memory unit 130, and the touch-control display panel 140 are electrically connected to the microprocessor 110. The camera 120 is configured to capture the captured image M in the image capturing direction and transfer the captured image M to the microprocessor 110, to transmit the captured image M to the memory unit 130 and store the captured image M.

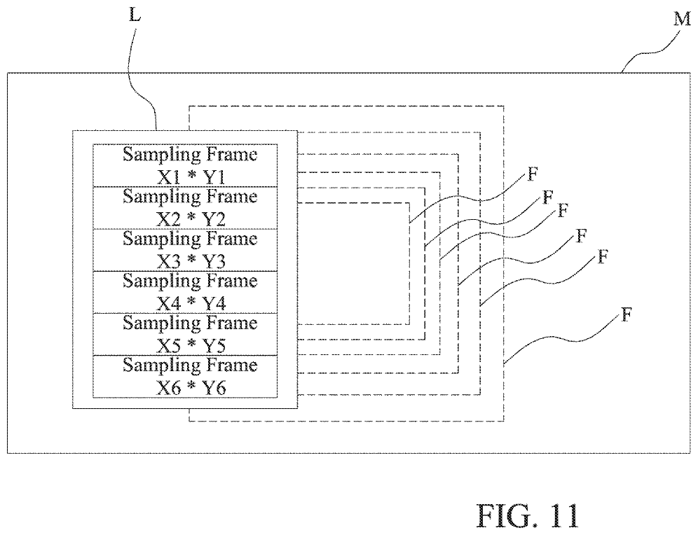

As shown in FIG. 10 and FIG. 11, the microprocessor 110 defines a plurality of sampling frames F having different sizes in the captured image M, and loads one of the sampling frames F in advance.

As shown in FIG. 10, the memory unit 130 is configured to store, in addition to the captured image M, an operating system and a necessary photography application program, and the memory unit 130 stores set values of the sampling frame F to be loaded by the microprocessor 110 to perform an object tracking mode.

As shown in FIG. 10 and FIG. 11, the touch-control display panel 140 is electrically connected to the microprocessor 110, and is configured to display a captured image M, receive a touch control operation, and feedback the touch control operation to the microprocessor 110 as a selection command. The above-mentioned sensitivity can be set by using the touch-control display panel 140. The remote control device 300 sends the value of the sensitivity by the touch control operation of the user, and the second communications interface 220 of the tracking dock 200 receives the value of the sensitivity and sends the optical encoding signal to the control chip 210. It is noted that the handheld mobile device 100 only serves as an operation interface for input the value of the sensitivity, the handheld mobile device 100 is not involved in tracking the remote control device 300.

As shown in FIG. 10 and FIG. 11, the microprocessor 110 may change the loaded sampling frame F according to the selection command. A manner of inputting the selection command may be shown in FIG. 11. An independent selection list L or a selection list L that pops up in the captured image M is displayed, and options of the sampling frames F having different sizes in ascending order are displayed, so that a user chooses a sampling frame in the touch-control display panel 140.

As shown in FIG. 1 and FIG. 10, the first communications interface 150 is electrically connected to the microprocessor 110, and is configured to establish a communications link. The first communications interface 150 may be a wired communications interface, for example, a USB interface, or may be a wireless communications interface, for example, Bluetooth, an RF communications interface, and a Wi-Fi interface (supporting Wi-Fi Direct).

As shown in FIG. 1, FIG. 2, and FIG. 10, different keys in the key group 320 are configured to trigger the encoding circuit 310 to send other optical-code signals of turning on or off a capturing function, enabling or disabling a tracking mode, triggering a shutter for capturing a single photo, or performing another operation. The other optical-code signals are received by the tracking dock 200, and are then transferred to the handheld mobile device 100 through the first communications interface 150 and the second communications interface 220, so that related functions of the handheld mobile device 100 are performed by using the remote control device 300. In addition, the selection command is not necessarily generated by the touch-control display panel 140, the encoding circuit 310 may prestore a plurality of sequence numbers, and each sequence number corresponds to one sampling frame F. Choosing commands or sequence numbers of different sampling frames F may be sent cyclically by continuously pressing keys in the key group 320, to enable the handheld mobile device 100 to load the corresponding sampling frames F.

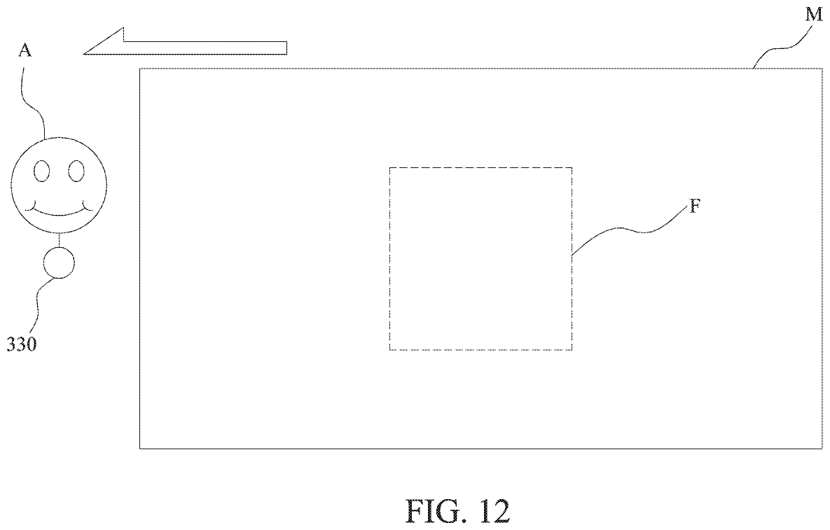

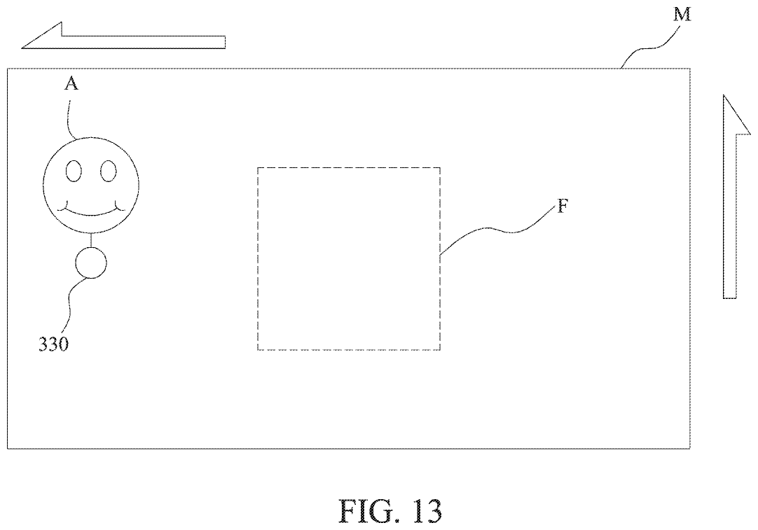

As shown in FIG. 12 and FIG. 13, the optical signal source 330 is disposed together with the feature object A. Therefore, when the image capturing direction approaches the optical signal source 330, the feature object A usually enters the captured image M.

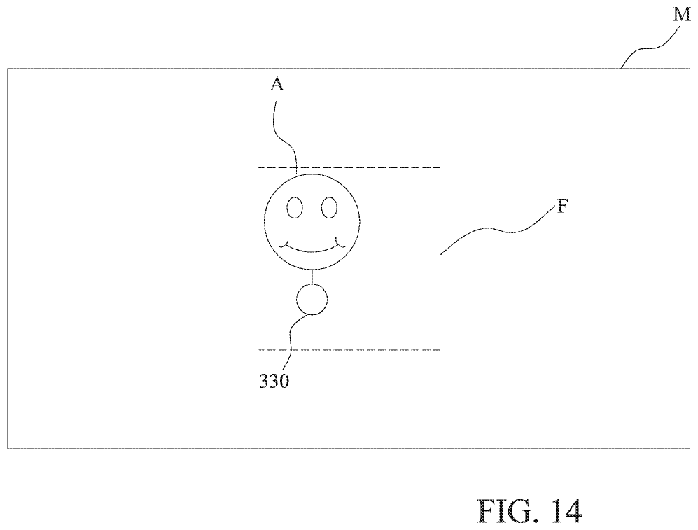

As shown in FIG. 13 and FIG. 14, in this case, if the handheld mobile device 100 enables the object tracking mode, the microprocessor 110 loads one of the sampling frames F in advance, and continuously recognizes the feature object A. When the feature object A moves beyond the loaded sampling frame F, the microprocessor 110 sends a second turning signal to drive the turning module 230 to change the image capturing direction, to enable the feature object A to return into the sampling frame F.

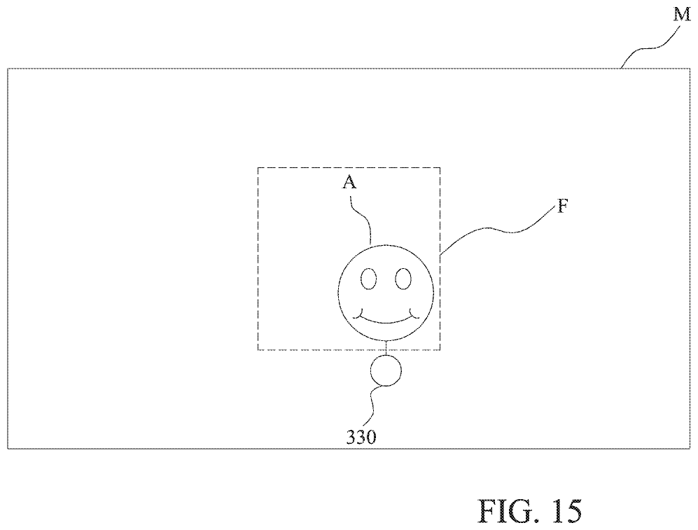

As shown in FIG. 15, if the feature object A keeps moving in the captured image M while keeping staying in the sampling frame F, the image capturing direction does not change. In this way, compared with a manner of continuously tracking the feature object A, the captured image M in the embodiment of the present invention may be kept relatively stable, and an image capturing direction is changed only when the feature object A displaces by a large distance.

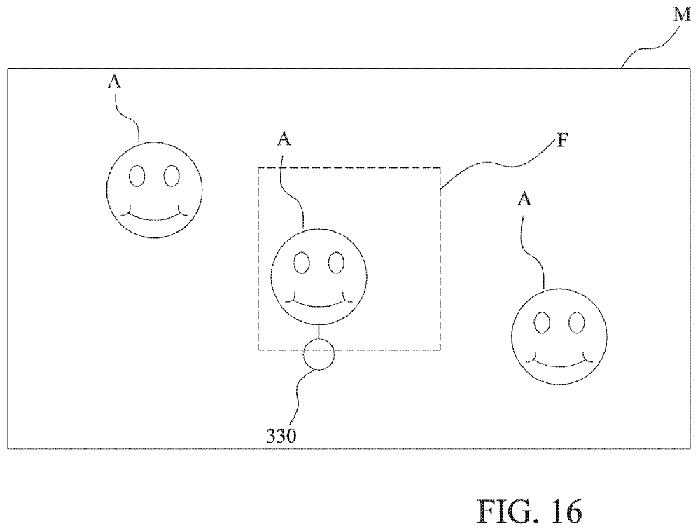

As shown in FIG. 16, in a scene with many people, the face of each person is recognized as a feature object A, so that the microprocessor 110 recognizes a plurality of feature objects A at the same time. In this case, the microprocessor 110 may adjust a scale to keep all the feature objects A in the sampling frame F, or keep a chosen feature object A in the sampling frame F according to a choosing command.

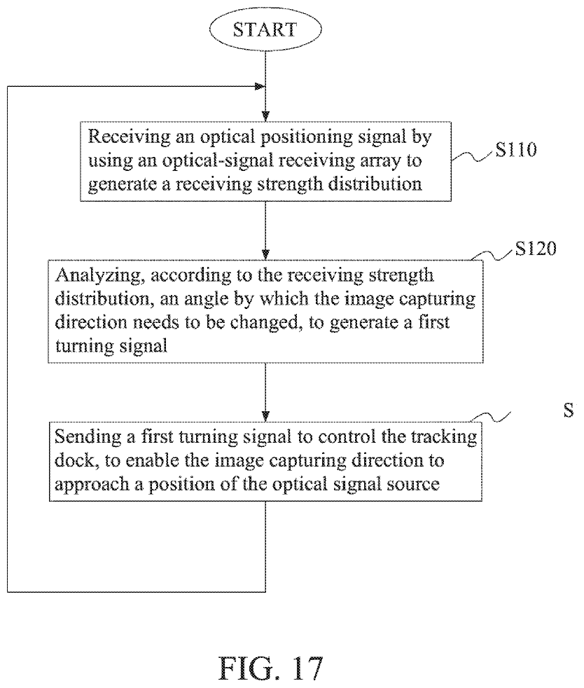

As shown in FIG. 17, a method for object tracking with an image-stabilizing function of the present invention is adapted for making an image capturing direction of a tracking dock 200 approaches an optical signal source 330. The optical signal source 330 is configured to send an optical positioning signal S. The method includes the following steps.

The optical positioning signal S is received by using an optical-signal receiving array 240, and a receiving strength distribution is generated, as shown in step S110.

A control chip 210 analyzes, according to the receiving strength distribution, an angle by which the image capturing direction needs to be changed, to generate a first turning signal, as shown in step S120.

The control chip 210 sends the first turning signal to control the tracking dock 200, to enable the image capturing direction to approach a position of the optical signal source 330, as shown in step S130.

As discussed above, when the image capturing direction approaches the optical signal source 330, a feature object A usually enters a captured image M. In this case, a handheld mobile device 100 may enable an object tracking mode. Moreover, a function of tracking the optical signal source 330 by the tracking dock 200 may be turned off by using an operation on a remote control device 300.

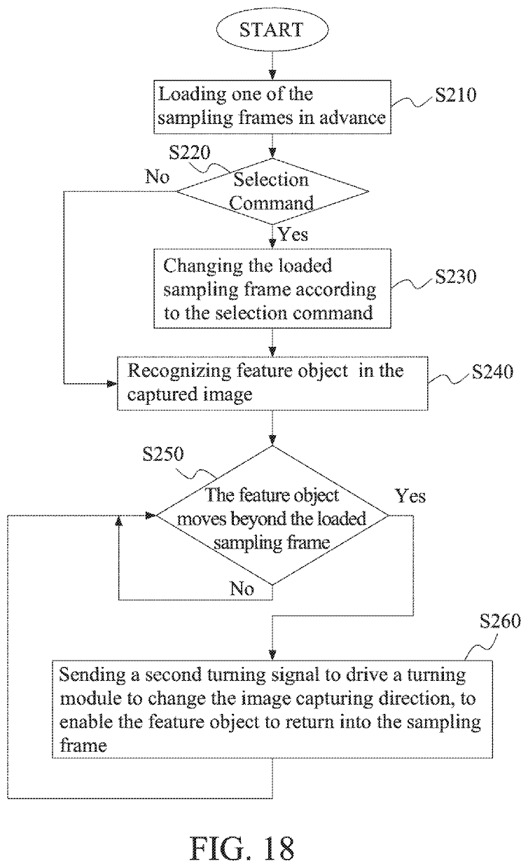

As shown in FIG. 18, after the handheld mobile device 100 enables the object tracking mode, a communications link is established between the tracking dock 200 and the handheld mobile device 100, and the handheld mobile device 100 captures the captured image M in the image capturing direction by using a camera 120.

The handheld mobile device 100 defines a plurality of sampling frames F having different sizes in the captured image M, and loads one of the sampling frames F in advance, as shown in step S210. If a selection command is input, the loaded sampling frame F is changed according to the selection command, as shown in steps S220 and S230.

The feature object A is recognized in the captured image M, as shown in step S240. When the feature object A moves beyond the loaded sampling frame F, the handheld mobile device 100 sends a second turning signal to drive a turning module 230 to change the image capturing direction, to enable the feature object A to return into the sampling frame F, as shown in steps S250 and S260.

Similarly, when a plurality of feature objects A are recognized in step S240, the handheld mobile device 100 may adjust a scale to keep all the feature objects A in the sampling frame F, or keep a chosen feature object A in the sampling frame F according to a choosing command.

In the present invention, an optical-code receiving array receives an optical positioning signal S, so that a receiving angle can be effectively increased to avoid a search failure and ensure that a feature object A that needs to be tracked is kept in a captured image M. A sampling frame F may be set rapidly, so that excessive tracking can be avoided, and the problem that the captured image M is unstable and shaky is resolved.

1. An object tracking system with an image-stabilizing function, comprising:
a remote control device, having:
a housing;
an encoding circuit, disposed within the housing;
an optical signal source, disposed on a surface of the housing, and electrically connected to and driven by the encoding circuit to emit an optical positioning signal; and
a key group, disposed on the surface of the housing, electrically connected to the encoding circuit, and configured to be pressed to trigger the encoding circuit to drive the optical signal source to send the optical positioning signal; and
a tracking dock, comprising:
a control chip;
a turning module, electrically connected to the control chip, wherein an image capturing direction is defined on the turning module, and the control chip is configured to control the turning module to turn, to change the image capturing direction; and
an optical-signal receiving array, disposed on the turning module and electrically connected to the control chip, rotating synchronously with the turning module, wherein the optical signal receiving array has a plurality of signal receiving units configured to receive the optical positioning signal and generate different receiving strengths according to respective different receiving distances and angles, so as to generate a receiving strength distribution of the receiving strengths and transfer the receiving strength distribution to the control chip;
wherein a threshold group of the signal receiving units is defined in a central area of the optical-signal receiving array, and the control chip compares the receiving strength distribution, and analyzes, according to the receiving strength distribution, whether the receiving strengths of optical-signal receiving units in the threshold group exceed a threshold to obtain a required receiving strength distribution; and
wherein when the receiving strength of at least one of the optical-signal receiving units in the threshold group does not reach the threshold, the control chip generates a first turning signal and sends the first turning signal to control the turning module to turn the optical-signal receiving array to a direction having a relatively high receiving strength according to a position of the optical-signal receiving unit having the relatively high receiving strength in the optical-signal receiving array until the receiving strengths of all of the optical-signal receiving units in the threshold group reach the threshold.

2. The object tracking system with an image-stabilizing function according to claim 1, further comprising a handheld mobile device, supported on the turning module, wherein the handheld mobile device comprises:
a microprocessor;
a camera, electrically connected to the microprocessor, and configured to capture a captured image in the image capturing direction and transfer the captured image to the microprocessor; wherein the microprocessor defines a plurality of sampling frames having different sizes in the captured image, and loads one of the sampling frames in advance, and the microprocessor changes the loaded sampling frame according to a selection command;
a memory unit, electrically connected to the microprocessor, and configured to store the captured image and set values of the sampling frames; and
a touch-control display panel, electrically connected to the microprocessor, and configured to display the captured image, receive a touch control operation, and feedback the touch control operation as the selection command to the microprocessor;
wherein the microprocessor recognizes a feature object in the captured image, and when the feature object moves beyond the loaded sampling frame, the microprocessor sends a second turning signal to drive the turning module to change the image capturing direction, to enable the feature object to return into the sampling frame.

3. The object tracking system with an image-stabilizing function according to claim 2, wherein when a plurality of feature objects is recognized, the microprocessor keeps all of the feature objects in the sampling frame.

4. The object tracking system with an image-stabilizing function according to claim 2, wherein when a plurality of feature objects is recognized, the microprocessor keeps a chosen feature object in the sampling frame according to a choosing command.

5. The object tracking system with an image-stabilizing function according to claim 1, wherein an array type of the optical-signal receiving array is selected from a rectangular array, an annular array, a trapezoidal array, a cross-shaped array, and a combination thereof.

6. A method for object tracking with an image-stabilizing function, adapted for making an image capturing direction of a tracking dock approach an optical signal source, wherein the optical signal source is configured to emit an optical positioning signal, the method comprising:
receiving the optical positioning signal by using an optical-signal receiving array, and generating a receiving strength distribution, wherein the optical-signal receiving array is disposed on a turning module of the track dock and has a plurality of signal receiving units configured to receive the optical signal and generate different receiving strengths according to respective different receiving distances and angles, so as to generate the receiving strength distribution of the receiving strengths;
defining a threshold group of the signal receiving units in a central area of the optical-signal receiving array and analyzing, according to the receiving strength distribution, whether the receiving strengths of optical-signal receiving units in the threshold group exceed a threshold; and
when the receiving strength of at least one of the optical-signal receiving units in the threshold group does not reach the threshold, generating a first turning signal and sending the first turning signal to the tracking dock to turn the optical-signal receiving array to a direction having a relatively high receiving strength according to a position of the optical-signal receiving unit having the relatively high receiving strength in the optical-signal receiving array, until the receiving strengths of all of the optical-signal receiving units in the threshold group reach the threshold.

7. The method for object tracking with an image-stabilizing function according to claim 6, further comprising:
establishing a communications link with a handheld mobile device; wherein the tracking dock is configured to support the handheld mobile device, and the handheld mobile device captures an captured image in the image capturing direction by using a camera;
defining, by the handheld mobile device, a plurality of sampling frames having different sizes in the captured image, and loading one of the sampling frames in advance; and
recognizing, by the handheld mobile device, a feature object in the captured image, and when the feature object moves beyond the loaded sampling frame, sending, by the handheld mobile device, a second turning signal to drive the tracking dock to change the image capturing direction, to enable the feature object to return into the sampling frame.

8. The method for object tracking with an image-stabilizing function according to claim 7, further comprising:
inputting a selection command, to enable the handheld mobile device to change the loaded sampling frame according to the selection command.

9. The method for object tracking with an image-stabilizing function according to claim 6, wherein when a plurality of feature objects is recognized, all of the feature objects are kept in the sampling frame.

10. The method for object tracking with an image-stabilizing function according to claim 6, wherein when a plurality of feature objects is recognized, a chosen feature object is kept in the sampling frame according to a choosing command.
